(19) United States
(12) Patent Application Publication
(10) Pub. No.: US 2006/0016598 A1
(43) Pub. Date: Jan. 26, 2006

(54) Lightweight proppant and method of making same

(76) Inventor: Thomas Wilhelm Urbanek, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 10/911,679

(22) Filed: Jul. 21, 2004

(51) Int. Cl. C09K 8/00; E21B 43/267; E21B 43/16

(52) U.S. Cl. 166/280.2; 166/269

(57) ABSTRACT

A lightweight, high-strength proppant is disclosed, comprising the formation of finely dispersed ceramic precursors and sintering at low temperatures, causing the formation and retention of mesopores and micropores in pelletized ceramic. A method of manufacturing such a proppant is also disclosed, comprising the steps of manufacturing finely divided ceramic precursors and additives using grinding, milling, and preferably sol-gel processes, and dispersing the finely divided ceramic precursors and additives in a liquid, preferably water. The dispersion has a viscosity profile, which permits the shaping of spheres using conventional pelletizing techniques. Drying of the pellets and sintering at temperatures below 1,400.degrees. C. forms and retains mesopores and micropores in the ceramic. Preferred total pore volumes range from 0.05 to 0.7 cm.sup.3/g. The pelletized and porous ceramic is useful as lightweight and high-strength proppants.

### FIELD OF THE INVENTION

Lightweight particles, commonly referred to as proppants, are provided for use in oil and gas wells. The particles are useful to prop open subterranean formation fractures.

### BACKGROUND OF THE INVENTION

Hydraulic fracturing is a process of injecting fluids into an oil or gas bearing formation at sufficiently high rates and pressures such that the formation fails in tension and fractures to accept the fluid. In order to hold the fracture open once the fracturing pressure is released, a propping agent (proppant) is mixed with the fluid and injected into the formation. Hydraulic fracturing increases the flow of oil or gas from a reservoir to the well bore in at least three ways: (1) the overall reservoir area connected to the well bore is increased, (2) the proppant in the fracture has significantly higher permeability than the formation itself, and (3) the highly conductive (propped) channels create a large pressure gradient in the reservoir past the tip of the fracture.

Proppants are preferably spherical particulates that resist high temperatures, pressures, and the corrosive environment present in the formation. If proppants fail to withstand the closure stresses of the formation, they disintegrate, producing fines or fragments, which reduce the permeability of the propped fracture. Early proppants were based on silica sand, glass beads, sand, walnut shells, or aluminum pellets. For its sensible balance of cost and compressive strength, silica sand (frac-sand) is still the most widely used proppant in the fracturing business. Its use, however, is limited to closure stresses of 6,000 psi. Beyond this depth resin-coated and ceramic proppants are used. Resin-coated and ceramic proppants are limited to closure stresses of 8,000 and 12,000 psi, respectively.

According to a study for the U.S. Department of Energy, published in April 1982 (Cutler and Jones, ‘Lightweight Proppants for Deep Gas Well Stimulation’ DOE/BC/10038-22), ideal proppants for hydraulic fracturing would have a specific gravity less than 2.0 g/cm.sup.3, be able to withstand closure stresses of 138 MPa, be chemically inert in brine at temperatures to 200.degrees. C., have perfect sphericity, cost the same as sand on a volume basis, and have a narrow proppant size distribution. The report concludes that such a proppant is not likely to be forthcoming in the foreseeable future.

U.S. Pat. No. 4,493,875 to Beck et al. discloses the manufacture of lightweight composite particles, the core of which is a conventional proppant particle, such as silica sand. The core has a thin coating containing hollow glass microspheres. Proppant particles manufactured in accordance with the invention have apparent densities ranging from of 1.3 to 2.5 g/cm.sup.3. Proppants manufactured according to this invention are not much stronger than the core particle itself and are, due to the cost of the resin and hollow glass spheres, quite expensive to manufacture.

U.S. Pat. No. 5,030,603 to Rumpf and Lemieux teaches the manufacture of lightweight ceramic proppants with apparent specific gravities ranging from 2.65 to 3.0 g/cm.sup.3 from calcined Kaolin clay having particle sizes of less than 8 micron. The clay is mixed with an organic binder, then pelletized and sintered at 1,400.degrees. C. Disadvantages of this invention are that the proppants have a relative high apparent specific gravity and are limited to closure stresses of 8,000 psi.

U.S. Pat. No. 5,120,455 to Lunghofer discloses the manufacture of lightweight ceramic proppants with apparent specific gravities of approximately 2.65 g/cm.sup.3 by sintering a mixture largely containing alumina and silica at 1,200 to 1,650.degrees. C. The proppants show significant conductivity at closure stresses of 12,000 psi. The main disadvantage of this invention is that the proppants still have a relative high apparent specific gravity.

U.S. Pat. No. 6,364,018 to Brannon, Rickards, and Stephenson discloses the manufacture of proppants with apparent specific gravities ranging from 1.25 to 1.35 g/cm.sup.3 from resin-coated ground nut hulls. The patent discloses low conductivities at closure stresses of 2,200 psi. The use of the proppants, therefore, is limited to shallow wells.

U.S. Pat. No. 6,753,299 to Lunghofer et al. claims the use of using quartz, shale containing quartz, bauxite, talc, and wollastonite as raw materials. The proppant contains as much as 65% quartz, and has yielded sufficient strength to be used in wells to a pressure of 10,000 psi. The apparent specific gravity of the proppant is approximately 2.62 g/cm.sup.3. The patent provides some improvements on U.S. Pat. NO. 5,120,455, cited above, by reducing the specific gravity of the proppants and by introducing cost savings due to an increased use of silica in the composition.

U.S. patent application Ser. No. 10/804,868 to Urbanek, assigned to the present applicant, teaches the manufacture of lightweight ceramic proppants with apparent specific gravities ranging from 1.4 to 1.9 g/cm.sup.3 using sol-gel processes. The application claims the preferred use of two exothermic chemical compositions commonly referred to as ‘Geopolymers’ and ‘Phosphate Cements’.

At the present time, commercially used lightweight proppants are manufactured from ceramics and have an apparent specific gravity of 2.7 g/cm.sup.3. The proppants are manufactured in accordance with U.S. Pat. No. 5,120,455, cited above. The present invention addresses the perceived limitations in the art by providing a novel lightweight proppant and method of manufacturing the same.

### SUMMARY OF THE INVENTION

The invention provides a composition and method useful to the manufacture of lightweight proppants. In a preferred method, ceramic precursors are manufactured by using sol-gel processes. The precursors are dispersed in a low temperature boiling liquid, preferably water. The dispersion has a viscosity that is suitable for the material to be pelletized. The pellets are dried and heated to temperatures sufficient to cause sintering of the ceramic precursors, but otherwise minimized for economic reasons and not to cause undesirable densification of the porous ceramic. The process introduces pores of desired size, preferably mesopores and micropores, into the ceramics, making the ceramics lightweight and compressively strong and, therefore, highly suited to the manufacture of lightweight proppants.

It is, therefore, one object of this invention to provide improved proppants for oil and gas wells, which are strong in compression and have low apparent specific gravities, and can be made more economically than presently available materials.

According to a first aspect of the present invention there is provided a lightweight, high-strength proppant formed from ceramic precursors and comprising pores less than 100 nanometers in diameter.

According to a second aspect of the present invention there is provided a method of forming lightweight, high-strength proppants comprising the steps of:
(a) forming an at least one ceramic precursor;
(b) dispersing the at least one ceramic precursor in a low-temperature boiling liquid to form a dispersion;
(c) pelletizing the dispersion to form pellets having pores containing liquid;
(d) drying the pellets to remove the liquid in the pores;
(e) sintering the pellets; and
(f) forming the pellets into generally spheroid bodies.

In preferred embodiments of the present invention, the pores are micropores or mesopores wherein the pore volume is 0.05 to 0.7 cm.sup.3/g, and the proppants have a specific gravity of 1.0 to 2.9 g/cm.sup.3 and a compressive strength of 14 to 104 MPa. The forming of the at least one ceramic precursor preferably comprises use of sol-gel processes. The method of the present invention may comprise the step of finely dividing the at least one ceramic precursor after forming the at least one ceramic precursor but before dispersing the at least one ceramic precursor, and the finely dividing is then preferably achieved by grinding and milling (although it may also be achieved by chemical redox processes or chemical neutralizations), the grinding and milling being undertaken if sol-gel processes are not used or if additives such as fillers need to be finely divided. The dispersing preferably takes place in a liquid having a boiling point of less than 150.degrees. C., with the liquid being water, and the sintering preferably takes place at a temperature of less than 1400.degrees. C. (and most preferably at a temperature of less than 850.degrees. C.). The forming of the pellets into generally spheroid bodies is preferably caused by a technique selected from the group consisting of agglomeration, spray granulation, wet granulation, spheronizing, extruding and pelletizing, vibration-induced dripping, spray nozzle formed droplets and selective agglomeration. The method may comprise the further step of coating the pellets after forming the pellets into generally spheroid bodies, the coating of the pellets then preferably comprising use of a coating selected from the group consisting of organic coating, epoxy, furan, phenolic resins and combinations thereof.

The at least one ceramic precursor may comprise a ceramic oxide (preferably selected from the group consisting of alumina, aluminum hydroxide, pseudo boehmite, kaolin clay, kaolinite, silica, clay, talc, magnesia and mullite, although it may also be selected from the group consisting of sulfates, acetates and nitrates), and the method of the present invention may comprise the step of introducing at least one additive to the at least one ceramic precursor before dispersing the at least one ceramic precursor, wherein the additive is a filler or inorganic pore former; the filler is then preferably selected from the group consisting of fly ash, sludges, slags, waste paper, rice husks, saw dust, volcanic aggregates, expanded perlite, pumice, obsidian, diatomaceous earth mica, borosilicates, clays, oxides, fluorides, sea shells, coral, hemp fibers, silica, inorganic and organic hollow spheres, mineral fibers, chopped fiberglass and combinations thereof, while the inorganic pore former is preferably selected from the group consisting of carbonates, acetates, nitrates, silica and alumina microspheres, polyethylene, polystyrene and ground walnut shells.

The invention provides a composition and method useful to economically manufacture lightweight proppants of high compressive strength. Proppants manufactured according to the present invention have an apparent specific gravity of 1.0 to 2.9 g/cm.sup.3 and a compressive strength of 14 to 104 MPa. When compared on volume bases to presently manufactured lightweight proppants, both the high pore volume and the lower heat capacity of the porous ceramic reduce manufacturing costs. The viscosity profile of the dispersed ceramic precursors and additives permits the use of conventional pelletizing techniques and the production of highly spherical and near monodisperse particles.

### DETAILED DESCRIPTION OF PREFERRED EMBODIMENTS

Following is a detailed description of preferred embodiments of the present invention wherein is described the use of porous ceramics in the manufacture of particulate ceramics, commonly referred to as proppants. The ceramics contain pores preferably less than 100 nanometer in size. Pores of such size are commonly referred to as mesopores and micropores. Preferred total pore volumes range from 0.05 to 0.7 cm.sup.3/g.

Porous ceramics have previously been used in many applications, such as refractories, filters, abrasives, fuel cells, bone implants, catalyst substrates, catalysts, drying agents, diffusion layers, heat exchange components, thermal insulators, sound barriers, and wicks.

In 1953, Ryshekewitch and Duckworth examined the ‘Compression Strength of Porous Sintered Alumina and Zirconia’ (Journal of the American Ceramic Society, 36 [2] 65, 1953) and (Journal of the American Ceramic Society, 36 [2] 68, 1953). The authors found that the compressive strength of porous sintered Alumina and Zirconia exponentially decreases with increasing pore concentrations. The relationship between porosity and compressive strength was described by the equation:
sigma=sigma0 exp(−bP)
where sigma is the stress at failure of the porous structure in compression, sigma0 is the stress at failure of the nonporous structure, P describes the pore volume in percent, and b is an empirical constant.

In 1997, Liu published a paper on the ‘Influence of Porosity and Pore Size on the Compressive Strength of Porous Hydroxyapatite Ceramics’ (Ceramics International, Vol. 23, 135 (1997). Liu found that the compressive strength of porous Hydroxyapatite ceramics decreases linearly with increasing macropore sizes for a given total pore volume. The examined ceramics had macropores 0.093 to 0.42 mm in diameter.

According to the present invention, pore-containing ceramics are formed by dispersing finely divided ceramic precursors in a liquid, removal of the liquid preferably by heating, and heating of the dried ceramic precursors to temperatures, which cause sintering but limit undesirable densification. Preferred are pores sizes commonly referred to as mesopores and micropores. Said pores are formed in the voids between solid particles, which are originally occupied by the liquid.

Unexpectedly, when these finely divided ceramic precursors are sintered at temperatures below 1,400.degrees. C., lightweight ceramics of high compressive strength are produced, which are highly suited to the manufacture of lightweight, high-strength proppants.

Ceramic precursors used in the present invention preferably are comprised of compounds, commonly known as ceramic oxides, and may include alumina, aluminum hydroxide, pseudo boehmite, kaolin clay, kaolinite, silica, clay, talc, magnesia, and mullite. Ceramic oxides may also be formed through chemical processes, such as redox processes or neutralizations, from compounds, such as sulfates, acetates, and nitrates, during the stage of manufacturing finely divided ceramic precursors, modifying the precursors with additives, shaping the precursors, and sintering the precursors. Those skilled in the art will recognize the extent of the list of ceramic oxides in the manufacture of ceramics. It is apparent that ceramic oxides of lower specific gravity require lower concentrations of pores than those of higher specific gravity in order to produce porous ceramics of equal specific gravity. Because of the logarithmic relationship between compressive strength and pore concentration, the use of ceramic oxides of lower specific gravity in the manufacture of porous ceramics of high compressive strength is preferred.

Finely divided ceramic precursors may be manufactured by using technologies, such as grinding and milling, and preferably sol-gel processes. Sols are suspended dispersions of a solid in a liquid. Gels are mixtures of a solid and liquid with an internal network structure so that both the liquid and solid are in highly dispersed state.

Fillers may be added to achieve desired economical targets, and physical and chemical properties of the proppant during the mixing of the chemical components, forming and sintering of the particles, and the field performance of the lightweight proppants. Compatible fillers include waste materials, such as fly ash, sludges, slags, waste paper, rice husks, saw dust, and natural materials, such as volcanic aggregates, expanded perlite, pumice, obsidian, and minerals, such as diatomaceous earth mica, borosilicates, clays, oxides, fluorides, and plant and animal remains, such as sea shells, coral, hemp fibers, and manufactured materials, such as silica, inorganic and organic hollow spheres, mineral fibers, chopped fiberglass.

Inorganic pore formers such as carbonates, acetates, and nitrates, and inorganic or organic hollow spheres, such as silica and alumina microspheres, and organic polymers, such as polyethylene and polystyrene, and natural materials, such as ground walnut shells, may also be used to increase the total pore volume and add pores of larger size.

The finely divided ceramic precursors and additives are dispersed in a liquid. For the purpose of this invention, the liquid preferably has a boiling point less than 150.degrees. C. More preferably, the liquid is water.

The dispersions utilized in this invention have viscosity profiles that allow them to be shaped and sintered to form proppant particles. Viscosity profiles may be controlled by varying the solid content, particle size and shape of the dispersed solids, temperature, pH, and through the use of inorganic and organic additives, commonly known to be rheology modifiers, such as fillers, fibers, fugitive binders, surfactants and thickeners. A fugitive binder is a binder that substantially burns off at sintering temperatures.

The viscosity profiles of the dispersed ceramic precursors permit the use of sphere-forming techniques, such as agglomeration, spray granulation, wet granulation, spheronizing, extruding and pelletizing, vibration-induced dripping (U.S. Pat. No. 5,500,162), spray nozzle formed droplets (U.S. Pat. No. 4,392,987), selective agglomeration (U.S. Pat. No. 4,902,666), the use of which is incorporated herein by reference. The techniques allow the manufacture of ‘green’ pellets from the dispersed ceramic precursor.

It is known that sintering of porous ceramics at high temperatures causes loss of porosity, commonly known as densification (see Deng, Fukasawa, Ando, Zhang and Ohji, Microstructure and Mechanical Properties of Porous Alumina Ceramics Fabricated by the Decomposition of Aluminum Hydroxide, Journal of the American Ceramic Society, Vol. 84 (11), 2638, 2001).

It has been found that sintering of finely divided ceramic precursors can be accomplished at low, economical temperatures, which do not cause undesirable densification of the ceramics. For the purpose of this invention, sintering temperatures are kept below 1,400.degrees. C., more preferably below 850.degrees. C. At these temperatures, the porous sintered ceramics have sufficient strength for use as proppants, but also undesirable densification is avoided. Sintering at higher temperatures, however, may also be used to increase the density and compressive strength of the porous ceramic proppants, ultimately approaching the theoretical density and compressive strength of the nonporous ceramic proppants, in order to meet the requirements of the industry.

At sintering temperatures thermally induced chemical reactions may occur, such as dehydrations and dehydroxylations and the decomposition of anions such as nitrates, carbonates, or acetates. Such reactions may be used to form pores or finely divided ceramic precursors.

Porous ceramics manufactured according to the present invention have specific gravities of 1.0 to 2.9 g/cm.sup.3 and compressive strengths ranging from 14 to 104 MPa (2,000 to 15,000 psi), which makes them highly suited for use as proppants.

The disclosed lightweight proppants may be coated with organic coatings, such as epoxy, furan, and phenolic resins (U.S. Pat. No. 5,639,806), and combinations of these coatings to improve their performance characteristics and utility. The coating may be carried out in accordance with known methods of coating proppants and ceramics.

Proppants manufactured according to the present invention can meet a wide range of economic and physical requirements. As porosity of the ceramics is increased, proppants show less compressive strength, but also material and energy costs to manufacture the same volume of proppants are significantly reduced. Highly porous proppants, therefore, can be manufactured according to this invention to compete with frac-sand, and denser proppants can be tailored to be competitive with current ceramic proppants. This range is not readily adapted by other techniques.

### EXAMPLE 1

Example 1 illustrates the use of filled porous ceramics in the manufacture of lightweight proppants.

650 grams of Al.sub.2 (SO.sub.4).sub.3. XH.sub.2 O were dissolved in 50 kilograms of water. Concentrated aqueous NH.sub.4 OH was added with stirring to form a slurry having a final pH of 8.5. The slurry, having a viscosity of approximately 30 centipoise at 50.degrees. C., was blended with 90 kilograms of mullite powder. The blend was formed into porous spheres using conventional sphere-forming techniques. After drying at 90.degrees. C. for 16 hours followed by sintering at 1,000.degrees. C. for 3 hours, the filler was uniformly bonded with Al.sub.2 O.sub.3 from the aluminum hydroxide precipitate. The pellets had a crush strength of 35 MPa and a specific gravity of 1.75 g/cm.sup.3.

### EXAMPLE 2

Example 2 illustrates the use of unfilled porous ceramics in the manufacture of lightweight proppants.

160 liters of an aqueous solution of 8% by weight Al.sub.2 (SO.sub.4).sub.3 and 3% by weight MgSO.sub.4 were mixed with 120 liters of 8% NaOH. The precipitate was filtered under vacuum and washed with water. The cake was partially dried. Conventional sphere forming and sintering below 1,400.degrees. C. resulted in lightweight proppants made of MgAl.sub.2 O.sub.4 spinel, having an apparent specific gravity of 2.3 g/cm.sup.3.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. For example, porous ceramics may solely be used to manufacture proppants, the use of fillers, however, may improve the economical and physical properties of the proppants, so the embodiments described above are therefore meant to be merely illustrative. The invention is therefore to be considered limited solely by the scope of the appended claims.

Embodiments of the invention in which an exclusive property or privilege is claimed are defined as follows:

1. A lightweight, high-strength proppant formed from ceramic precursors and comprising pores less than 100 nanometers in diameter.

2. The proppant of claim 1 wherein the pores are micropores.

3. The proppant of claim 1 wherein the pores are mesopores.

4. The proppant of claim 1 having a specific gravity of 1.0 to 2.9 g/cm.sup.3.

5. The proppant of claim 1 having a compressive strength of 14 to 104 MPa.

6. The proppant of claim 1 wherein the pore volume is 0.05 to 0.7 cm.sup.3/g.

7. A method of forming lightweight, high-strength proppants comprising the steps of:
(a) forming an at least one ceramic precursor;
(b) dispersing the at least one ceramic precursor in a low-temperature boiling liquid to form a dispersion;
(c) pelletizing the dispersion to form pellets having pores containing liquid;
(d) drying the pellets to remove the liquid in the pores;
(e) sintering the pellets; and
(f) forming the pellets into generally spheroid bodies.

8. The method of claim 7 wherein the forming of the at least one ceramic precursor comprises use of sol-gel processes.

9. The method of claim 7 further comprising the step of finely dividing the at least one ceramic precursor after forming the at least one ceramic precursor but before dispersing the at least one ceramic precursor.

10. The method of claim 9 wherein the finely dividing is achieved by grinding and milling.

11. The method of claim 7 wherein the dispersing takes place in a liquid having a boiling point of less than 150.degrees. C.

12. The method of claim 7 wherein the liquid is water.

13. The method of claim 7 wherein the sintering takes place at a temperature of less than 1400.degrees. C.

14. The method of claim 13 wherein the sintering takes place at a temperature of less than 850.degrees. C.

15. The method of claim 7 wherein the at least one ceramic precursor comprises a ceramic oxide.

16. The method of claim 7 further comprising the step of introducing at least one additive to the at least one ceramic precursor before dispersing the at least one ceramic precursor.

17. The method of claim 16 wherein the at least one additive is a filler.

18. The method of claim 16 wherein the at least one additive is an inorganic pore former.

19. The method of claim 7 further comprising the step of coating the pellets after forming the pellets into generally spheroid bodies.

20. The method of claim 7 wherein the at least one ceramic precursor is selected from the group consisting of alumina, aluminum hydroxide, pseudo boehmite, kaolin clay, kaolinite, silica, clay, talc, magnesia and mullite.

21. The method of claim 9 wherein the finely dividing is caused by chemical redox processes.

22. The method of claim 9 wherein the finely dividing is caused by chemical neutralizations.

23. The method of claim 7 wherein the at least one ceramic precursor is selected from the group consisting of sulfates, acetates and nitrates.

24. The method of claim 17 wherein the filler is selected from the group consisting of fly ash, sludges, slags, waste paper, rice husks, saw dust, volcanic aggregates, expanded perlite, pumice, obsidian, diatomaceous earth mica, borosilicates, clays, oxides, fluorides, sea shells, coral, hemp fibers, silica, inorganic and organic hollow spheres, mineral fibers, chopped fiberglass and combinations thereof.

25. The method of claim 18 wherein the inorganic pore former is selected from the group consisting of carbonates, acetates, nitrates, silica and alumina microspheres, polyethylene, polystyrene and ground walnut shells.

26. The method of claim 7 wherein the forming of the pellets into generally spheroid bodies is caused by a technique selected from the group consisting of agglomeration, spray granulation, wet granulation, spheronizing, extruding and pelletizing, vibration-induced dripping, spray nozzle formed droplets and selective agglomeration.

27. The method of claim 19 wherein the coating of the pellets comprises use of a coating selected from the group consisting of organic coating, epoxy, furan, phenolic resins and combinations thereof.
